(19) United States
(12) Patent Application Publication
(10) Pub. No.: US 2006/0048068 A1
(43) Pub. Date: Mar. 2, 2006

(54) Method and system to facilitate access to a user interface element on a user interface

(76) Inventor: Michael Danninger, Landau (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/931,523

(22) Filed: Aug. 31, 2004

(51) Int. Cl. G06F 17/00

(52) U.S. Cl. 715/769; 715/810; 715/853

(57) ABSTRACT

A method, to facilitate access to a user interface element on a user, includes receiving a first selection of a user interface element from a user interface control on the user interface and, based on the first selection, regenerating a retrieval content area on the user interface. The retrieval content area integrated with and dedicated to the user interface control. The regeneration of the retrieval content area enables a user to select the user interface element from the retrieval content area.

### FIELD OF THE INVENTION

An embodiment relates generally to the technical field of accessing information via a network, in one exemplary embodiment, to facilitate access to a user interface element on a user interface.

### BACKGROUND OF THE INVENTION

Accessing information in a table or from a tree on a user interface may sometimes be hindered by large quantities of information. For example, a tree structure that includes a category that includes a sub-category that includes a leaf-category that includes an object may require each category to be opened before the object may be selected. Another example may include a table that requires scrolling through hundreds of records or rows before the desired record may be selected.

### SUMMARY OF THE INVENTION

A method to facilitate access to a user interface element on a user interface includes receiving a first selection of a user interface element from a user interface control on the user interface; and regenerating a retrieval content area on the user interface based on the first selection, the retrieval content area integrated with and dedicated to the user interface control and the regeneration of the retrieval content area to enable a user to select the user interface element from the retrieval content area.

A method to facilitate access to a user interface includes, at a first machine, generating a user interface data message that includes a user interface controller to receive a first selection of a user interface element from a user interface control on the user interface, the first selection to trigger a regeneration of a retrieval content area on the user interface, the retrieval content area integrated with and dedicated to the user interface control, the regeneration of the retrieval content area to enable the user to select the user interface element from the retrieval content area; and communicating the user interface data message from the first machine to the second machine.

### BRIEF DESCRIPTION OF THE DRAWINGS

The present invention is illustrated by way of example and not limitation in the figures of the accompanying drawings, in which like references indicate similar elements and in which:

FIG. 1 is a network diagram depicting a system, according to one exemplary embodiment of the present invention;

FIG. 2 is a block diagram illustrating enterprise applications and services, in one exemplary embodiment of the present invention;

FIG. 3 is a block diagram illustrating hardware and software components, according to an exemplary embodiment of the present invention;

FIG. 4 is a block diagram illustrating a user interface library and a user interface component with an accompanying model, according to an exemplary embodiment of the present invention;

FIG. 5 is a block diagram illustrating a user interface content area, according to an exemplary embodiment of the present invention, that includes multiple content areas that correspond to user interface components;

FIG. 6 is a block diagram illustrating a tree control with corresponding user interface element attributes, according to an exemplary embodiment of the present invention;

FIG. 7 is a block diagram illustrating user interface elements in a table control that corresponds to user interface element attributes, according to an exemplary embodiment of the present invention;

FIG. 8 is a flow chart illustrating a method, according to an exemplary embodiment of the present invention, to utilize a history content area to access a tree control;

FIG. 9 is a flow chart illustrating a method, according to an exemplary embodiment of the present invention, to facilitate access to a user interface;

FIG. 10 is a flow chart illustrating a method, according to an exemplary embodiment of the present invention, to facilitate access to a user interface element on a user interface;

FIG. 11 is a flow chart illustrating a method, according to an exemplary embodiment of the present invention, to utilize a utilize favorite content area for a tree control;

FIG. 12 is a flow chart illustrating a method, according to an exemplary embodiment of the present invention, to facilitate access to a user interface element on a user interface;

FIGS. 13-20 illustrate user interface screens, according to an exemplary embodiment of the present invention; and

FIG. 21 is a diagrammatic representation of a machine, in the exemplary form of a computer system, within which a set of instructions, for causing the machine to perform any one or more of the methodologies discussed herein, may be executed.

### DETAILED DESCRIPTION

A method and system to facilitate access to a user interface element on a user interface are described. In the following description, for purposes of explanation, numerous specific details are set forth in order to provide a thorough understanding of the present invention. It will be evident, however, to one skilled in the art that the present invention may be practiced without these specific details.

In general, embodiments described below feature a system to facilitate access to a user interface element on a user interface. A user uses a tree control that appears on a user interface (e.g., web page) on a computer to access Human Resource Information). For example, the top level of the tree control may include a folder entitled “Human Resources”. The user opens the “Human Resources” folder to reveal a folder entitled “Personnel”. Next, the user opens the “Personal” folder to reveal a folder entitled “Employee Resumes”. Next, the user opens the “Employee Resumes” folder to reveal a resume entitled “Bob Jones”. Finally, the user opens the resume for “Bob Jones”. Each time the user makes a selection from the tree control (e.g., opens a folder or opens an object which are examples of user interface elements), the selection is recorded in a history content area that is dedicated to the tree control. If the user wants to redisplay the resume of “Bob Jones” then the user may utilize the history content area to select the resume of “Bob Jones” instead of opening the “Human Resource”, “Personnel”, and “Employee Resume” folders to access the resume of “Bob Jones”.

In yet another embodiment, the user may utilize a favorite content area that is dedicated to the tree control to avoid making multiple selections from the tree control. For example, the user may select an “Employee Resume” folder from the tree control, drag the “Employee Resume” folder to a favorite content area, and drop the “Employee Resume” folder into the favorite content area. Henceforth, the user may select the “Employee Resume” folder from the favorite content area without opening the “Human Resource” and “Personnel” folders.

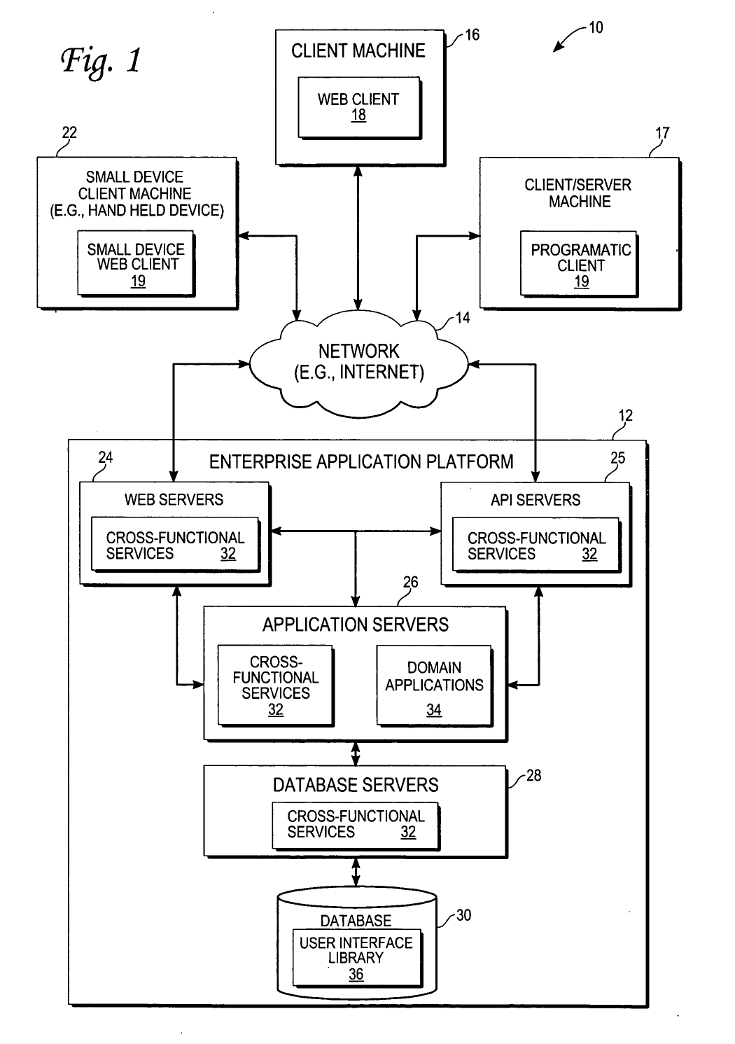

FIG. 1 is a network diagram depicting a system 10, according to one exemplary embodiment, having a client-server architecture. A platform (e.g., machines and software), in the exemplary form of an enterprise application platform 12, provides server-side functionality, via a network 14 (e.g., the Internet) to one or more clients. FIG. 1 illustrates, for example, a client machine 16 with web client 18 (e.g., a browser, such as the INTERNET EXPLORER browser developed by Microsoft Corporation of Redmond, Washington State), a small device client machine 22 with a small device web client 19 (e.g., a browser without a script engine) and a client/server machine 17 with a programmatic client 19.

Turning specifically to the enterprise application platform 12, web servers 24, and Application Program Interface (API) servers 25 are coupled to, and provide web and programmatic interfaces to, application servers 26. The application servers 26 are, in turn, shown to be coupled to one or more databases servers 28 that facilitate access to one or more databases 30. The web servers 24, Application Program Interface (API) servers 25, application servers 26, and database servers 28 host cross-functional services 32. The application servers 26 further host domain applications 34.

The cross-functional services 32 provide services to users and processes that utilize the information enterprise application platform 12. For instance the cross-functional services 32 provide portal services (e.g., web services), database services and connectivity to the domain applications 34 for users that operate the client machine 16, the client/server machine 17 and the small device client machine 22. In addition, the cross-functional services 32 provide an environment for delivering enhancements to existing applications and for integrating third party and legacy applications with existing cross-functional services 32 and domain applications 34. Further, while the system 10 shown in FIG. 1 employs a client-server architecture, the present invention is of course not limited to such an architecture, and could equally well find application in a distributed, or peer-to-peer, architecture system.

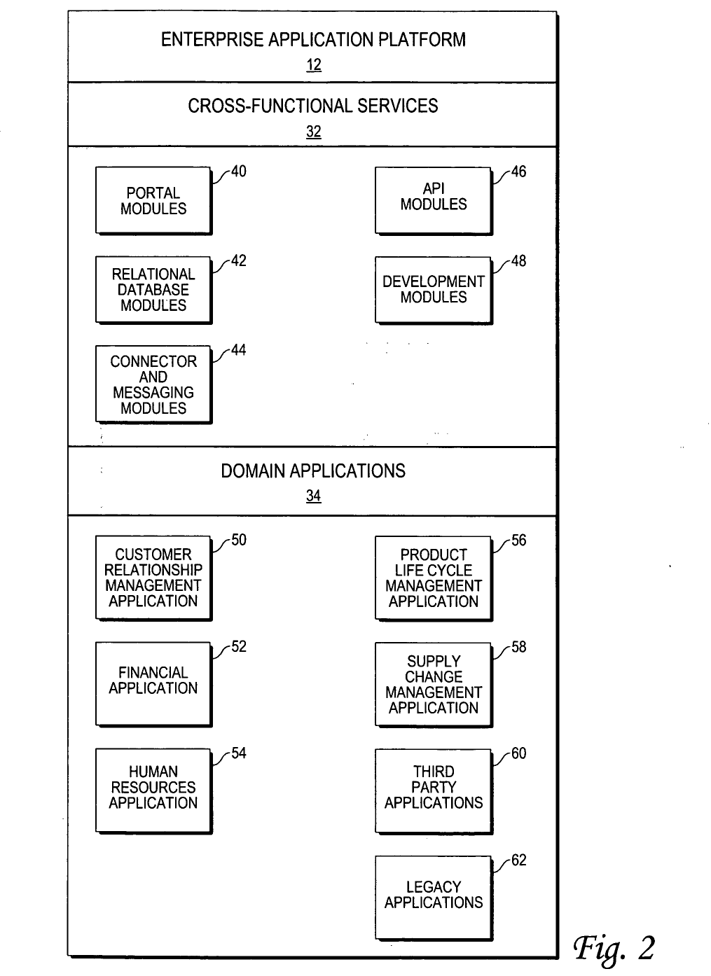

FIG. 2 is a block diagram illustrating enterprise applications and services as embodied in the enterprise application platform 12, according to an exemplary embodiment. The enterprise application platform 12 includes cross-functional services 32 and domain applications 34. The cross-functional services 32 include portal modules 40, relational database modules 42, connector and messaging modules 44, Application Program Interface (API) modules 46, and development modules 48.

The portal modules 40 enable a single point of access to other cross-functional services 32 and domain applications 34 for the client machine 16, the small device client machine 22 and the client/server machine 17. The portal modules 40 are utilized to process, author and maintain web pages that present content (e.g., user interface elements and navigational controls) to the user. In addition, the portal modules 40 enable user roles, a construct that associates a role with a specialized environment that is utilized by a user to execute tasks, utilize services and exchange information with other users and within a defined scope. For example, the role determines the content that is available to the user and the activities that the user may perform. The portal modules 40 include a generation module 64, a communication module 66, a receiving module 78 and a regenerating module 80 that are discussed further below. In addition the portal modules 40 comply with a variety of Internet technologies and web services standards, including Java, J2EE, SAP's Advanced Business Application Programming Language (ABAP) and Web Dynpro, XML, JCA, JAAS, X.509, LDAP, WSDL, WSRR, SOAP, UDDI and Microsoft.NET.

The relational database modules 42 provide support services for access to the database 30 that includes a user interface library 36. The relational database modules 42 provide support for object relational mapping, database independence and distributed computing. The relational database modules 42 are utilized to add, delete, update and manage database elements.

The connector and messaging modules 44 enable communication across different types of messaging systems that are utilized by the cross-functional services 32 and the domain applications 34 by providing a common messaging application processing interface. The connector and messaging modules 44 enable asynchronous communication on the enterprise application platform 12.

The Application Program Interface (API) modules 46 enable the development of service-based applications by exposing an interface to existing and new applications as services. Repositories are included in the platform as a central place to find available services when building applications.

The development modules 48 provide a development environment for the addition, integration, updating and extension of software components on the enterprise application platform 12 without impacting existing cross-functional services 32 and domain applications 34.

Turning to the domain applications 34, the customer relationship management applications 50 enable access to and facilitates collecting and storing of relevant personnelized information from multiple data sources and business processes. Enterprise personnel that are tasked with developing a buyer into a long-term customer may utilize the customer relationship management applications 50 to provide assistance to the buyer throughout a customer engagement cycle.

Enterprise personnel may utilize the financial applications 52 and business processes to track and control financial transactions within the enterprise application platform 12. The financial applications 52 facilitate the execution of operational, analytical and collaborative tasks that are associated with financial management. Specifically, the financial applications 52 enable the performance of tasks related to financial accountability, planning, forecasting, and managing the cost of finance.

The human resource applications 54 may be utilized by enterprise personal and business processes to manage, deploy, and track enterprise personnel. Specifically, the human resource applications 54 enable the analysis of human resource issues and facilitate human resource decisions based on real time information.

The product life cycle management applications 56 enable the management of a product throughout the life cycle of the product. For example, the product life cycle management applications 56 enable collaborative engineering, custom product development, project management, asset management and quality management among business partners.

The supply chain management applications 58 enable monitoring of performances that are observed in supply chains. The supply chain management applications 58 facilitate adherence to production plans and on-time delivery of products and services.

The third party applications 60, as well as legacy applications 62, may be integrated with domain applications 34 and utilize cross-functional services 32 on the enterprise application platform 12.

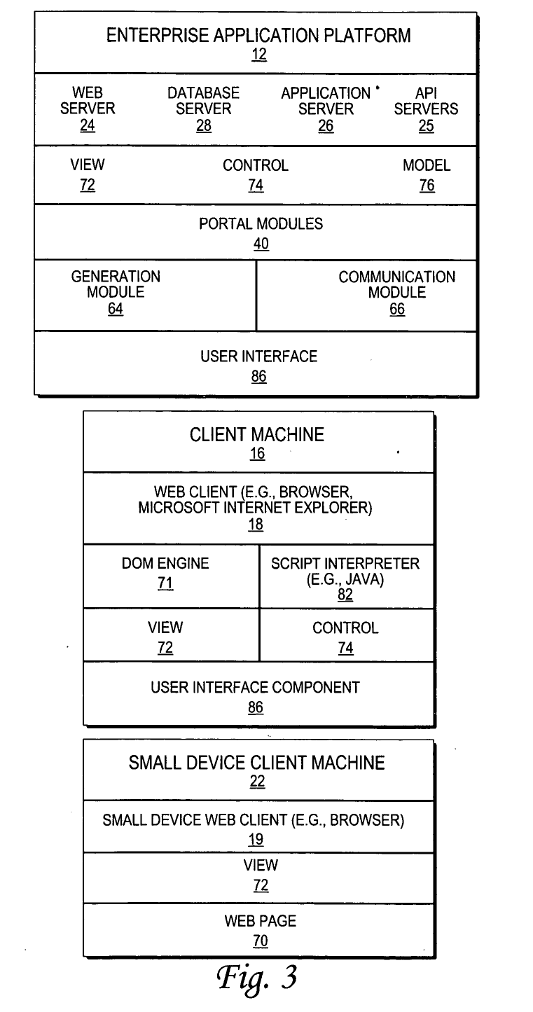

FIG. 3 illustrates hardware and software components utilized by an enterprise application platform 12, according to an embodiment. The illustrated hardware components include the enterprise application platform 12 that includes the servers previously described, the client machine 16 and the small device client machine 22.

The enterprise application platform 12 includes a view, control, model construct and portal modules 40. The view construct 72, controller construct 74, and model construct 76 illustrate a development pattern that is utilized to decouple user interface interaction into three distinct roles. The portal modules 40 include one or more user interface components 86, a generation module 64, and a communication module 66 that are collectively utilized to process user interface requests, generate user interface data messages, communicate user interface data messages, communicate user interfaces and regenerate user interfaces. Although a single user interface component 86 is illustrated, it should be noted that a user interface may include multiple user interface components 86 and that one user interface component 86 may be nested inside of another user interface component 86, each user interface component 86 associated with a particular area of the user interface (e.g., web page).

The client machine 16 includes a web client 18 that provides a platform for a DOM engine 71, a script interpreter 82, and one or more user interface components 86. The web client 18 enables a user to generate user interfaces, regenerate user interfaces and display user interfaces (e.g., web pages) that are downloaded from the web server 24 in the form of a user interface data message 101 that includes one or more user interface components 86. The display object model (DOM) engine 71 includes an Application Program Interface (API) to manipulate HTML screen objects, which are examples of user interface elements that are included as meta-data and page description language in a user interface component 86. For example, a user interface element may be a graphical image of a table, a list of items, text, numeric data, a menu of selectable links, a calendar with selectable date entries, etc. The DOM API provides access for manipulation of the user interface elements by software components in the user interface component 86 and the web client 18. The user interface component(s) 86 includes script that may be interpreted by the script interpreter 82.

The small device client machine 22 utilizes a small device web client 19 to display a web page 70 that is communicated to the small device client machine 22 from the enterprise application platform 12. Note that the small device web client 19 does not include a script interpreter 82.

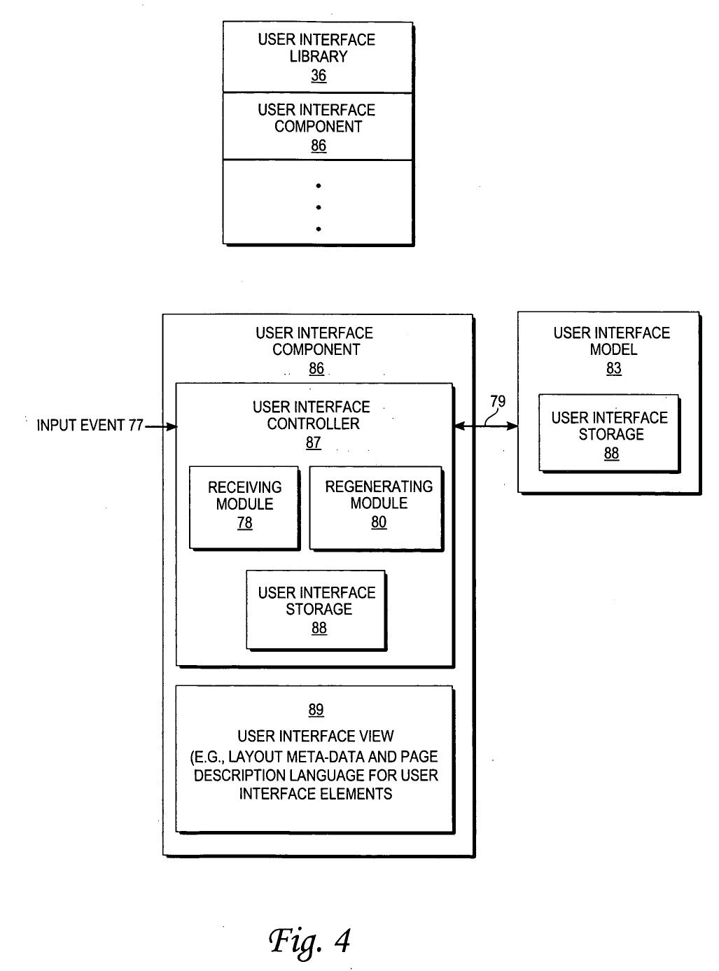

FIG. 4 is a block diagram illustrating a user interface library 36 and a user interface component 86 with an accompanying user interface model 83, according to an embodiment. The user interface library 36 includes user interface components 86 that are utilized to generate user interfaces (e.g., web pages) for the enterprise application platform 12.

The user interface component 86 includes a user interface controller 87, a user interface storage 88, and a user interface view 89. In addition each user interface component 86 is associated with a user interface model 83. The user interface view 89 includes parts of the user interface component 86 that interact with the user. For example, the user interface view 89 includes layout metadata and page description markup language (e.g., HTML, etc.) for the generation, formatting, and display of user interface elements 92. The layout metadata may define the layout of user interface elements 92 on the screen of a client device (e.g., the client machine 16, the small device client machine 22 or the client/server machine 17). The user interface elements 92 may include content (e.g., text, graphics, images, audio, etc.) and navigational controls (e.g., Button, checkbox, radio button group, links, etc.). Selecting a navigational control from a display (e.g., with a mouse, rollerball, etc.) may result in communication of an input event 77 to the user interface controller 87.

The user interface controller 87 processes input events 77 to determine the next user interface view(s) 89 to be displayed or to update the present user interface view 89 accordingly. The user interface controller 87 may read and store data in the user interface model 83 (e.g., as illustrated with an arrow 79). The user interface model 83 is an object or application that includes memory for storage in the form of user interface storage 88. The user interface model 83 hides business logic and persistence layers from the other parts of the user interface component 86 (e.g., view and control). The user interface controller 87 further includes user interface logic in the form of script including a receiving module 78, and a regenerating module 80. The receiving module 78 processes an input event 77 that is generated in response to a user selecting a user interface element 92 on a user interface. A selection may be an execution selection or a drag and drop selection. An execution selection is a selection that results in executing an activity associated with a user interface element (e.g., linking to a web page, registering a radio button, registering a box, etc.). A drag and drop selection does not execute the activity associated with a user interface element; but rather, is utilized to copy a user interface element from one part of a user interface to another part of a user interface. For example, a user may click and hold a mouse button that is positioned over a user interface element and then drag the selected user interface element to another part of the user interface.

The user interface storage 88 is utilized as private memory by the user interface controller 87. The user interface storage 88 is organized as a hierarchical structure of objects (e.g., that may reference sub-objects) that include data elements that may be bound to user interface elements 92 and/or attributes in the user interface model 83. In addition, the data elements in the user interface storage 88 of one user interface component 86 may be bound to a data element in another user interface component 86. The notion of binding implies an automatic flow of data between corresponding data elements, model attributes and user interface elements. Thus, data may travel automatically from a user interface element 92 to a user interface controller 87, to other another user interface controller 87 or to the user interface model 83 and vice versa.

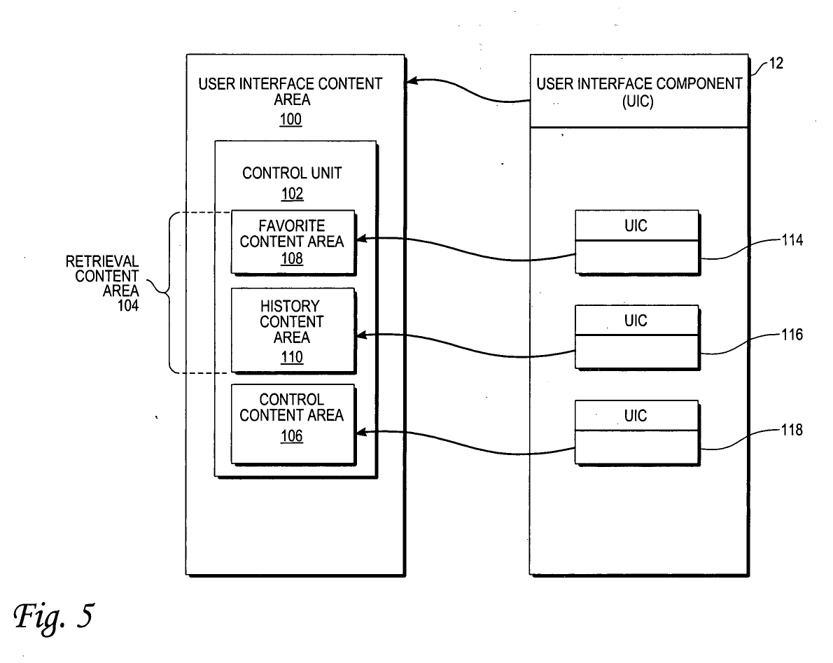

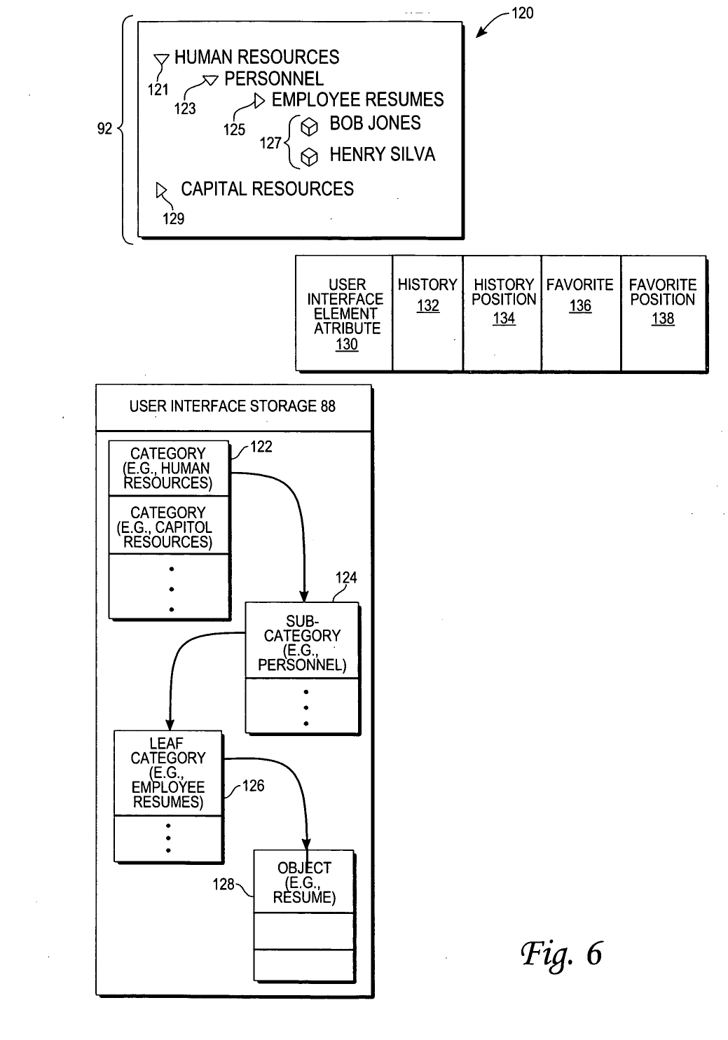

FIG. 5 is a block diagram illustrating a user interface content area 100, according to an exemplary embodiment, that includes multiple content areas that correspond to user interface components 86. The user interface content area 100 (e.g., web page) includes a control unit 102 that includes a retrieval content area 104 and a control content area 106. The control content area 106 includes user interface elements 92 for a user interface control (e.g., tree control, table control, etc.). The retrieval content area 104 may include user interface elements 92 that are utilized quickly to access the user interface control. The retrieval content area 104 includes a favorite content area 108 and a history content area 110. The favorite content area 108 may include a user's favorite selections that are available in the control content area 106 but not always easily accessible. For example, a favorite folder that is five folders deep in a tree control may be stored and immediately retrieved from the favorite content area 108. In addition, a user may quickly access a user interface element 92 (see FIG. 6) from the history content area 110, which includes the most recent selections by the user from the associated tree control. It will be appreciated that a user may utilize configuration controls to hide a display of the retrieval content area 104. For example, the user may utilize a set of configuration commands or user interface elements 92 to hide or display the retrieval content area 104, or the favorite content area 108 or the history content area 110.

Each of the content areas 106-110 corresponds to an area of the user interface 100 that appears on a client machine 16, a small device client machine 22 or a client/server machine 17. In addition, each of the content areas 106-110 corresponds to a user interface component 87. For example, the user interface content area 100, the favorite content area 108, the history content area 110 and the control content area 106 correspond to the user interface components 112, 114, 116 and 118 respectively. Further, one content area may nest another content area. For example, the user interface content area 100 includes the favorite content area 108 and the history content area 110. The nesting of content areas corresponds to a nesting of user interface components 87. For example, the user interface component 112 that is associated with the user interface content area 100 includes the user interface component 114, the user interface component 116 and the user interface component 118.

FIG. 6 is a block diagram illustrating a tree control 120, according to an exemplary embodiment, with user interface elements 92 that correspond to user interface element attributes 130. The tree control 120 includes user interface elements 92, as they might appear in a control content area 106 on a user interface (e.g., web page), including containers (e.g., folders) and objects (e.g., resumes). Other embodiments may feature other types of containers (e.g., web pages) and objects (e.g., user interface elements on a web page). The containers may be characterized as a category 121, 129, a sub-category 123 and a leaf-category 125. The category 121 is characterized as always appearing (e.g., it cannot be hidden) and located at the root level of a tree. The sub-category 123 and leaf-category 125 may be hidden (e.g., category 129 is illustrated as “closed” and may hide sub-categories and/or leaf categories) inside of another category. Further, the leaf category 125 may include one or more objects.

Each of the containers 121 and objects 127 correspond to entries in tables in the user interface storage 88. The containers 121 and 129 correspond to entries in a table 122; the container 123 corresponds to an entry in table 124; the container 125 corresponds to an entry in a table 126; and the objects 127 correspond to entries in a table 128. Each entry includes a user interface element attribute 130 that in turn includes a history attribute 132, a history position attribute 134, a favorite attribute 136 and a favorite position attribute 138. The history and favorite attributes 132, 136 may indicate that the corresponding user interface elements are displayed in the favorite content area 108 and the history content area 110, respectively. The history and favorite position attributes 134, 138 include data that is utilized to position the user interface element in the favorite content area 108 and the history content area 110, respectively. The user interface elements may be positioned in the respective content areas based on various sorting options (e.g., alphabetic, numeric, chronological, reverse chronological, etc.). In addition, a user may manually position user interface elements 92 (e.g., they appear wherever they are dropped) in the favorite content area 108.

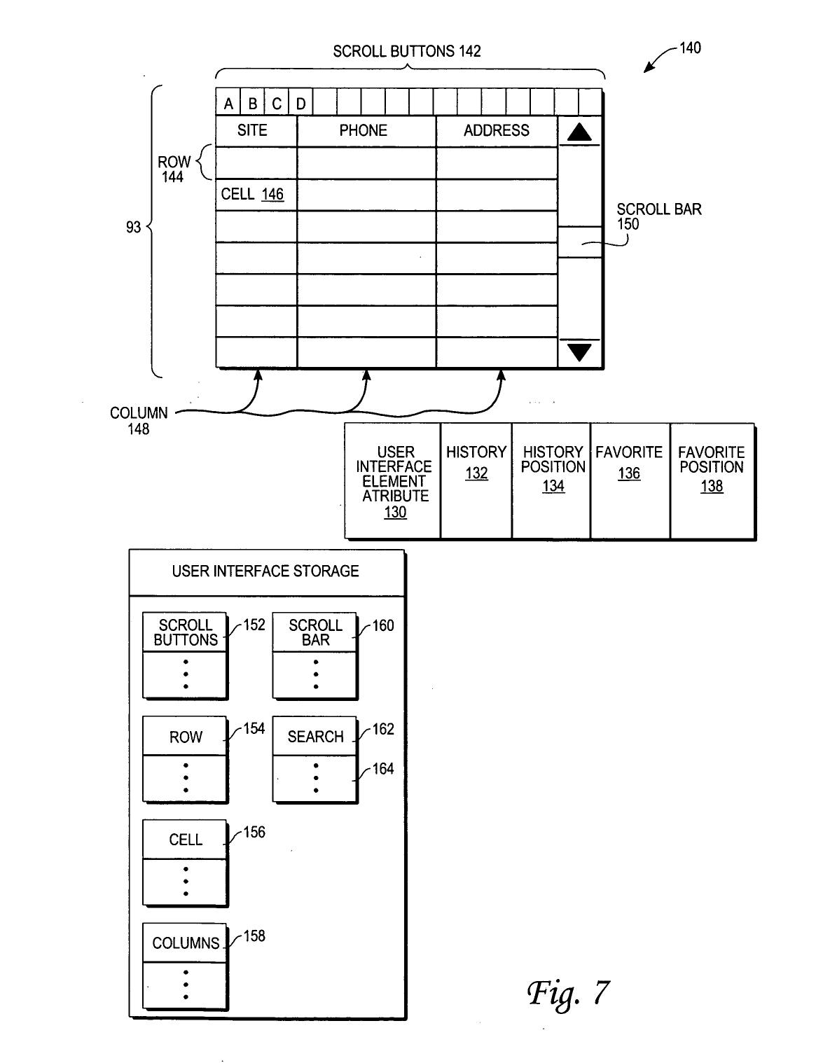

FIG. 7 is a block diagram illustrating a table control 140, according to an exemplary embodiment, with user interface elements 92 and corresponding user interface element attributes 130. The table control 140 includes user interface elements 93, as they might appear in a control content area 106 on a user interface (e.g., web page), that include scroll buttons 142, a row 144, a cell 146, a column 148, and a scroll bar 150.

Each of the user interface elements 93 corresponds to entries in tables in the user interface storage 88. The scroll buttons 142 correspond to entries in a table 152; the rows 144 correspond to entries in table 154; the cells 146 correspond to entries in a table 156; the columns 148 correspond to entries in a table 158; and discrete positions on the scroll bar 150 correspond to entries in a table 160. Each entry includes a user interface element attribute 130 that includes a history attribute 132, a history position attribute 134, a favorite attribute 136 and a favorite position attribute 138. The history and favorite attributes 132, 136 and the history and favorite position attributes 134, 138 operate as previously described. In addition, a search table 162 is utilized to store search parameters 164 that are input by the user to search the table. The search parameters 164 may include keywords and filters, and may be stored into and selected from the favorite content area 108 and the history content area 110.

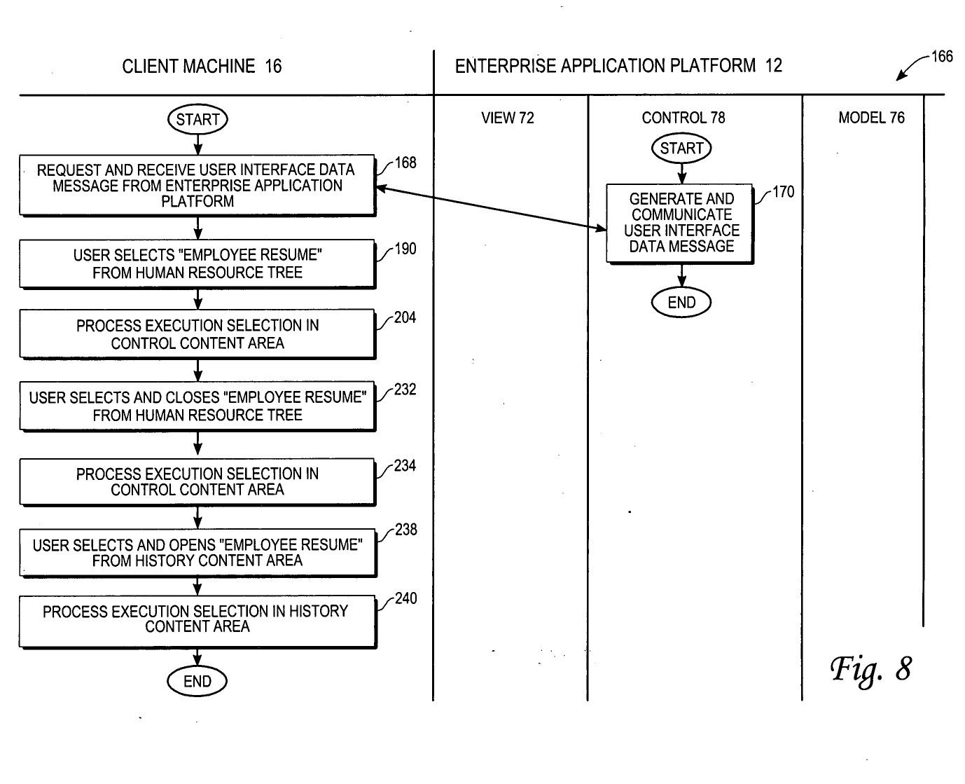

FIG. 8 is a flow chart illustrating a method 166, according to an embodiment, to utilize a history content area to access a tree control 120. The client machine 16 is illustrated on the left and the enterprise application platform 12 is illustrated on the right.

At box 168, a user at the client machine 16 selects a link for a web page (e.g., a Human Resource Information web page). In response, the client machine 16 communicates a request for the Human Resource Information web page to the enterprise application platform 12.

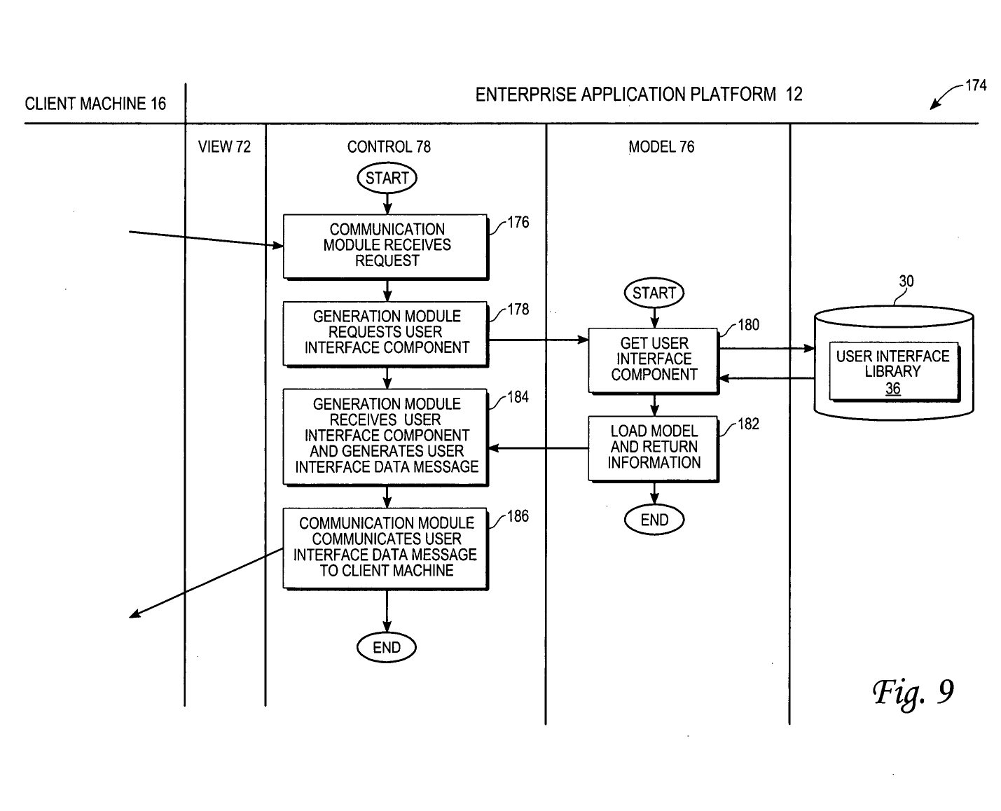

At box 170, the enterprise application platform 12 receives the request for the web page, generates a user interface data message 172 and communicates the user interface data message 172 to the client machine 16 as illustrated in FIG. 9, according to an embodiment.

FIG. 9 is a flow chart illustrating a method 174, according to an exemplary embodiment, to facilitate access to a user interface. The client machine 16 is illustrated on the left and the enterprise application platform 12 is illustrated on the right.

At box 176, the communication module 66, at the enterprise application platform 12, receives the request for the web page and invokes the generation module 64.

At box 178, the generation module 64 instantiates a user interface model 83 and, at box 180, utilizes the information in the request to identify the corresponding user interface components 86 in the user interface library 36 in the database 30.

At box 182, the user interface model 83 is populated with data from the user interface library 36, and the user interface components 86 are returned to the generation module 64. As previous described, the control unit 102 for a tree control 120 includes four user interface components 112, 114, 116 and 118, the user interface component 112 containing the user interface components 114, 116, and 118.

At box 184, the generation module 64 receives the user interface components 86 and generates a user interface data message 101 that indicates the user interface components 112, 114, 116 and 118 in the user interface data message 101.

At box 186, the communication module 66 communicates the user interface data message 101 to the client machine 16 and the processing ends.

Returning to FIG. 8, at box 168, the web client 18, at the client machine 16, reads the user interface data message 101 into memory and displays the Human Resource Information web page.

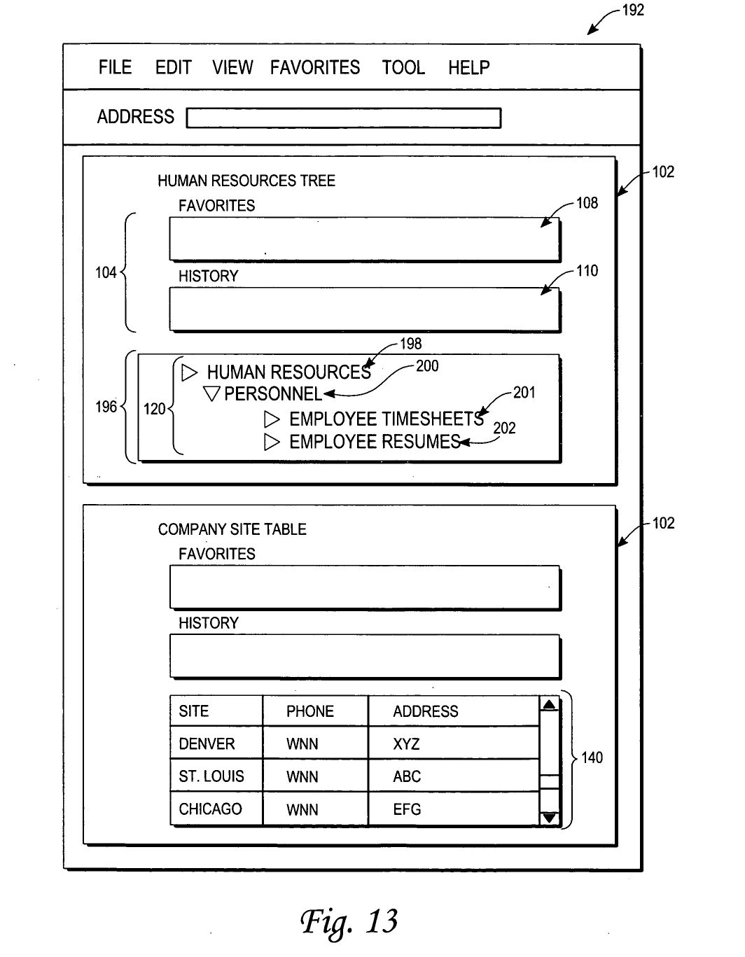

FIG. 13 illustrates a user interface 192, according to an embodiment, in the form of a Human Resource Information web page that includes a control unit 102 for a tree and a control unit 102 for a table. The control unit 102 for the tree includes a retrieval content area 104 and a control content area 196. The retrieval content area 104 includes a favorite content area 108 and a history content area 110. The control content area 196 includes a user interface control in the exemplary form of a tree control 120 that includes a human resources category 198, a personnel sub-category 200, an employee timesheets leaf-category 201 and an employee resumes leaf-category 202.

Returning to FIG. 8, at box 190, the user selects and thereby opens the employee resume leaf-category 201 on the tree control 120.

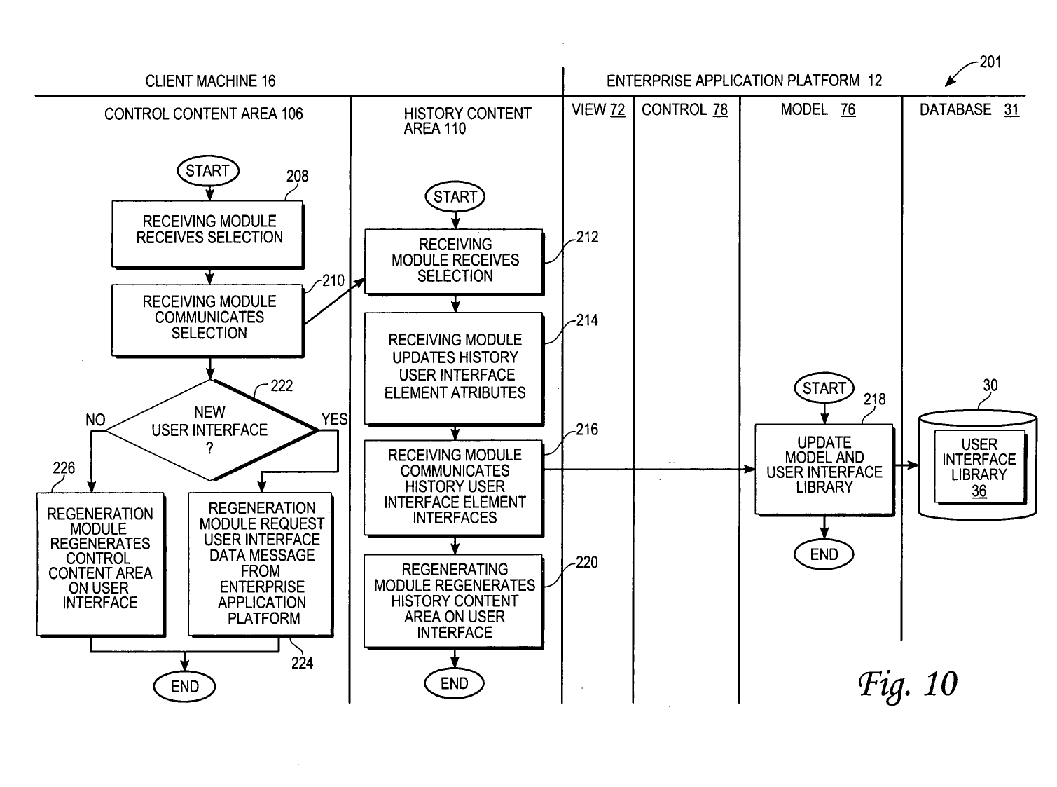

At box 204, the receiving module 78 in the user interface component 118 associated with the control content area 106 receives and processes an input event 77 as illustrated on FIG. 10.

FIG. 10 illustrates a method 206, according to an exemplary embodiment, to facilitate access to a user interface element on a user interface. The client machine 16 is illustrated on the left and the enterprise application platform 12 is illustrated on the right.

At box 208, the receiving module 78 for the control content area 106 receives the user selection in the form of an input event 77 and, at box 210, communicates the selection to the receiving module 78 for the history content area 110.

At box 212, the receiving module 78, for the history content area 110, receives the user selection and, at box 214, updates the appropriate user interface element attribute associated with the user selection. For example, the history 132 attribute and the history position attribute 134 for the oldest selection would be updated and the history attribute 132 and the history position attribute 134 for the present selection would be updated.

At box 216, the receiving module 78, for the history content area 110, communicates the updated history attributes 132 and the history position attributes 134 to the user interface model 83.

At box 218, the user interface model 83 updates the data elements corresponding to the history attributes 132 and the history position attributes 134 and saves a persistent copy in the user interface library 36 in the database 30.

At box 220, the regenerating module 80 in the history content area 110 regenerates the history content area 110 on the user interface to include the most recent selection by the user and processing ends

At decision box 222, the regenerating module 80 in the control content area 106 determines whether to generate a new user interface. A branch is made to box 224 if the regenerating module 80 determines that a new user interface should be generated. Otherwise a branch is made to box 226.

At box 224, the regenerating module 80 in the control content area 106 request a new user interface (e.g., web page) and communicates a request to the enterprise application platform where it is processed as previously described in the method 174 on FIG. 9.

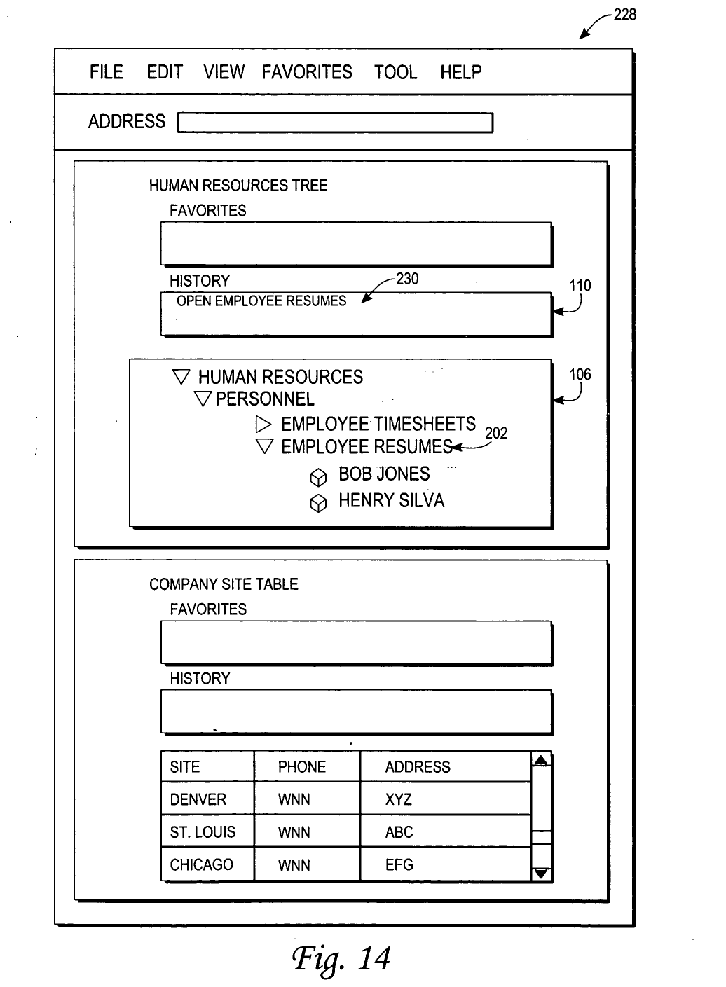

At box 226, the regenerating module 80 for the control content area 106 regenerates the control content area 106 on the user interface in response to the user selection (e.g., opening the employee resume leaf-category 202) and processing ends. FIG. 14 illustrates a user interface 228, according to an embodiment, that includes an updated control content area 106 and an updated history content area 110. The history content area 110 is updated to include the most recent user selection (e.g., a string 230, “OPEN EMPLOYEE RESUMES”) and the control content area 106 is updated responsive to the user selection (e.g., the employee resume leaf-category 202 is opened).

Returning to FIG. 8, at box 232, the user selects and closes the employee resume leaf category 202 from the tree 196 thereby generating of an input event 77.

At box 234, the receiving module 78 in the user interface component 118 associated with the control content area 106 receives and processes the input event 77 as previously described in the method 206 that is illustrated on FIG. 10.

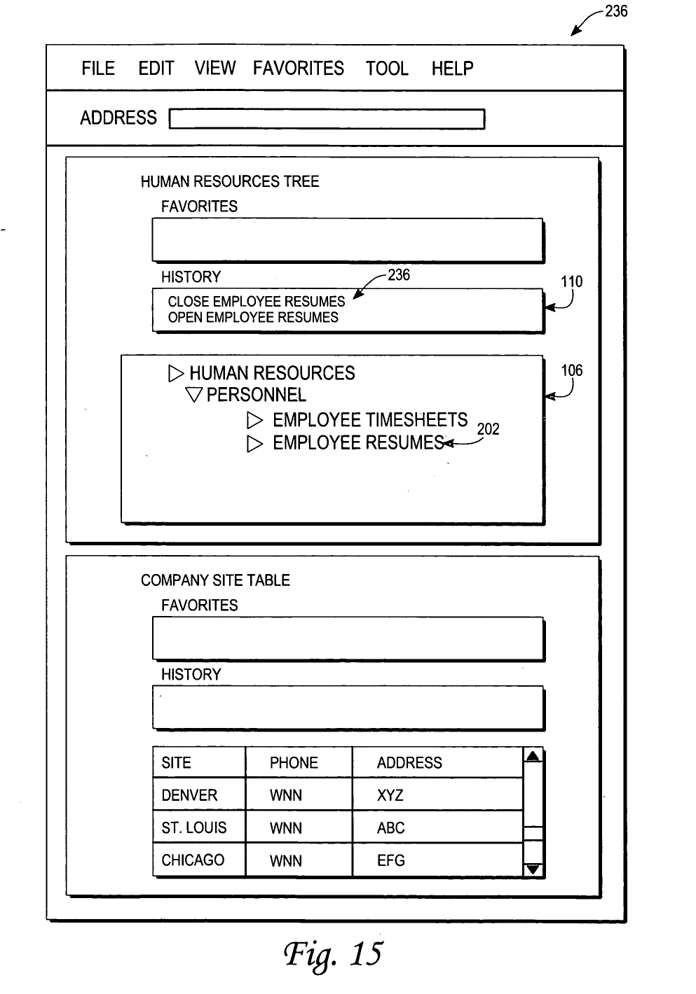

FIG. 15 illustrates a user interface 236, according to an embodiment, that includes an updated control content area 106 and an updated history content area 110. The history content area 110 is updated to include the most recent user selection (e.g., a string 236, “CLOSE EMPLOYEE RESUMES”) and the control content area 106 is updated responsive to the user selection (e.g., the employee resume leaf-category 202 is closed).

Returning to FIG. 8, at box 238, the user selects the string 230, “OPEN EMPLOYEE RESUMES”, from the history content area 110 thereby generating of an input event 77.

At box 240, the receiving module 78, in the user interface component 116 associated with the history content area 110, receives the input event 77 and forwards the input event 77 to the user interface component 118 associated with the control content area 106.

At box 240, the receiving module 78 in the user interface component 118 associated with the control content area 106 receives and processes the input event 77 as previously described in the method 206, as illustrated on FIG. 10.

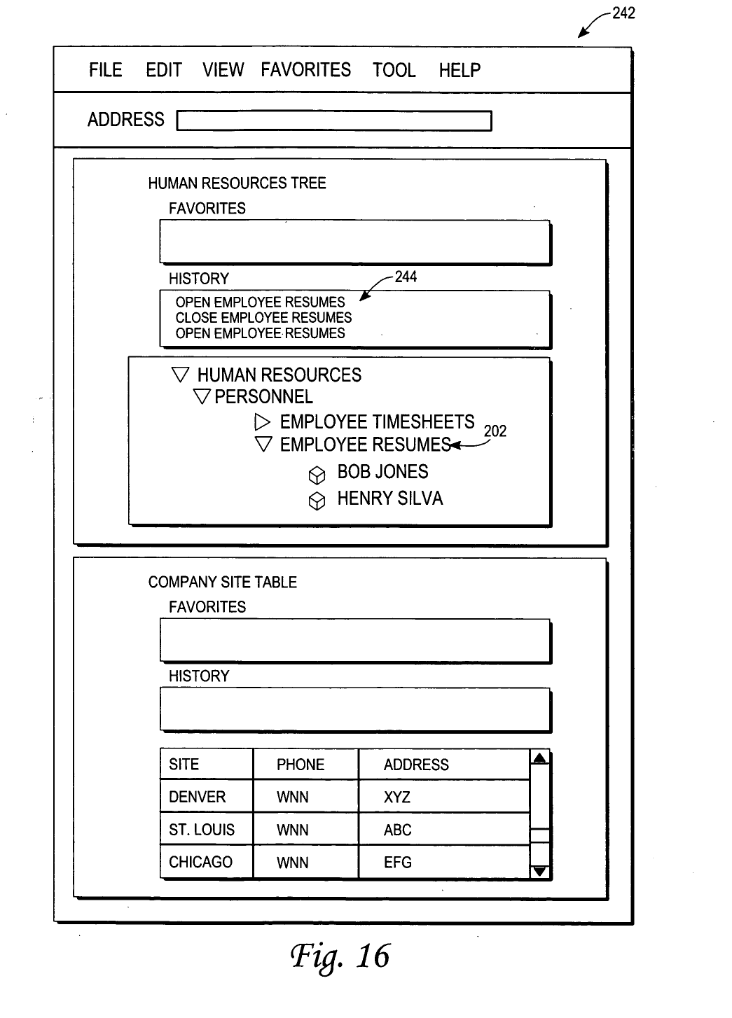

FIG. 16 illustrates a user interface 242, according to an embodiment, that includes an updated control content area 106 and an updated history content area 110. The history content area 110 is updated to include the most recent user selection (e.g., a string 244, “OPEN EMPLOYEE RESUMES”) and the control content area 106 is updated responsive to the user selection (e.g., the employee resume leaf-category 202 is opened).

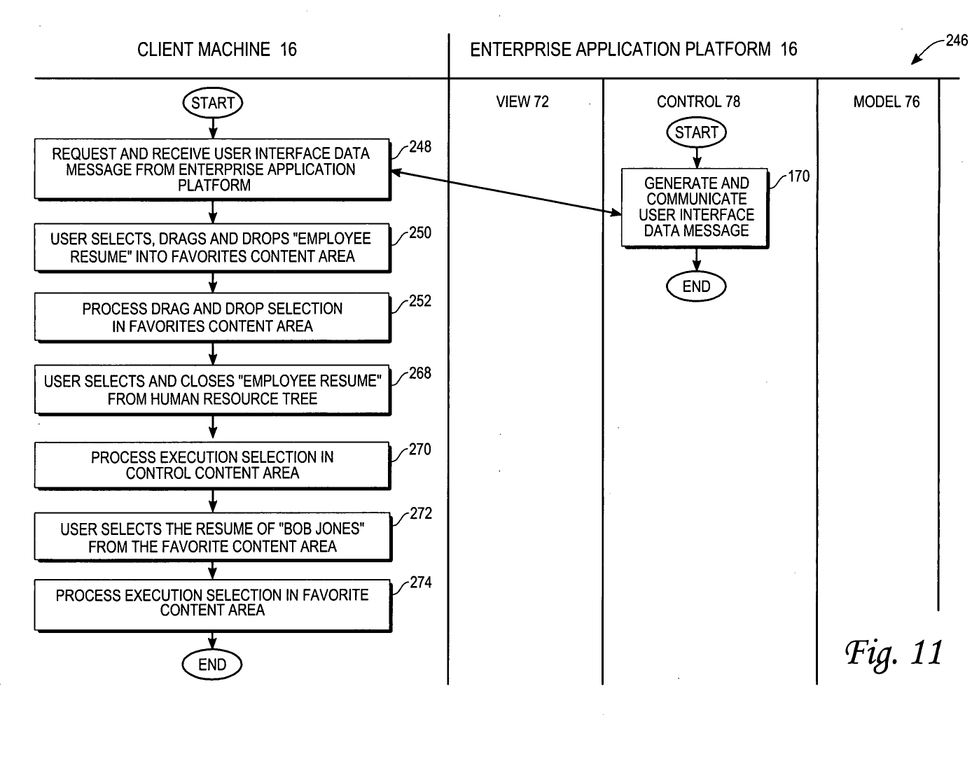

FIG. 11 illustrates a method 246, according to an embodiment, to utilize a favorite content area to access a tree control 120. The client machine 16 is illustrated on the left and the enterprise application platform 12 is illustrated on the right.

At box 248, a user at the client machine 16 selects a link for a Human Resource Information web page. In response, the client machine 16 communicates a request for the Human Resource Information web page to the enterprise application platform 12.

At box 170, the enterprise application platform 12 receives the request for the web page, generates a user interface data message 172 and communicates the user interface data message 172 to the client machine 16 as previously described in method 174 and illustrated on FIG. 9, according to an embodiment.

Returning to FIG. 11, at box 248, the web client 18, at the client machine 16, reads the user interface data message 101 into memory, displays the Human Resource Information web page.

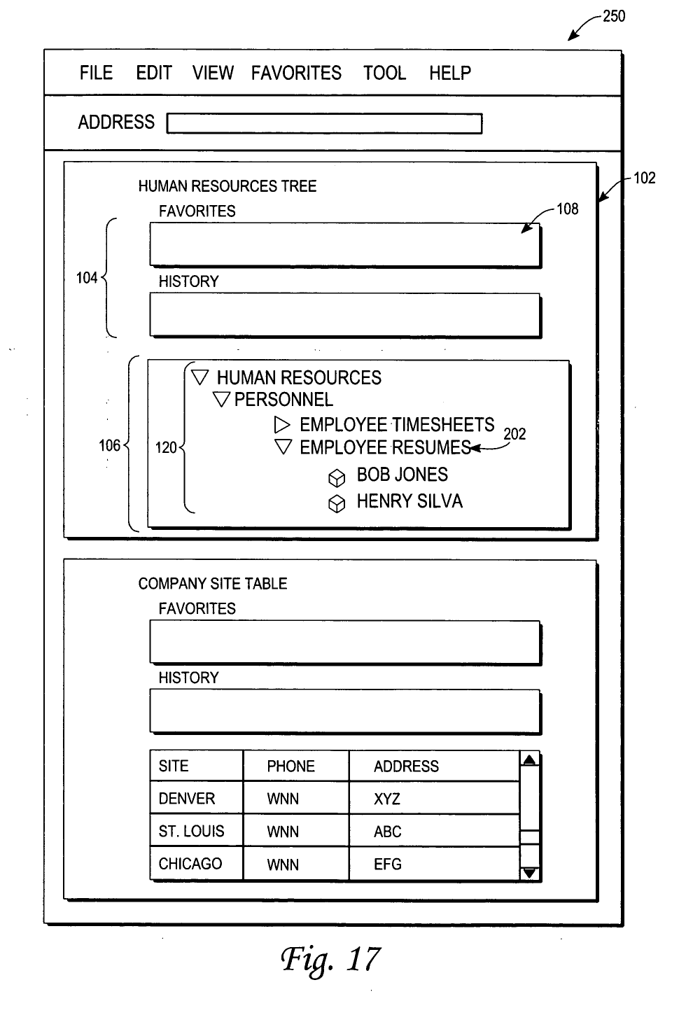

FIG. 17 illustrates a user interface 250, according to an embodiment, for a Human Resource Information web page that includes a control unit 102 that includes a retrieval content area 104 and a control content area 106. The retrieval content area 104 includes a favorite content area 108. The control content area 106 includes a user interface control in the exemplary form of tree control 120 that includes an employee resumes leaf-category 202.

Returning to FIG. 11, at box 250, the user selects and drags the employee resume leaf-category 202 from the tree control 120 to the favorite content area 108.

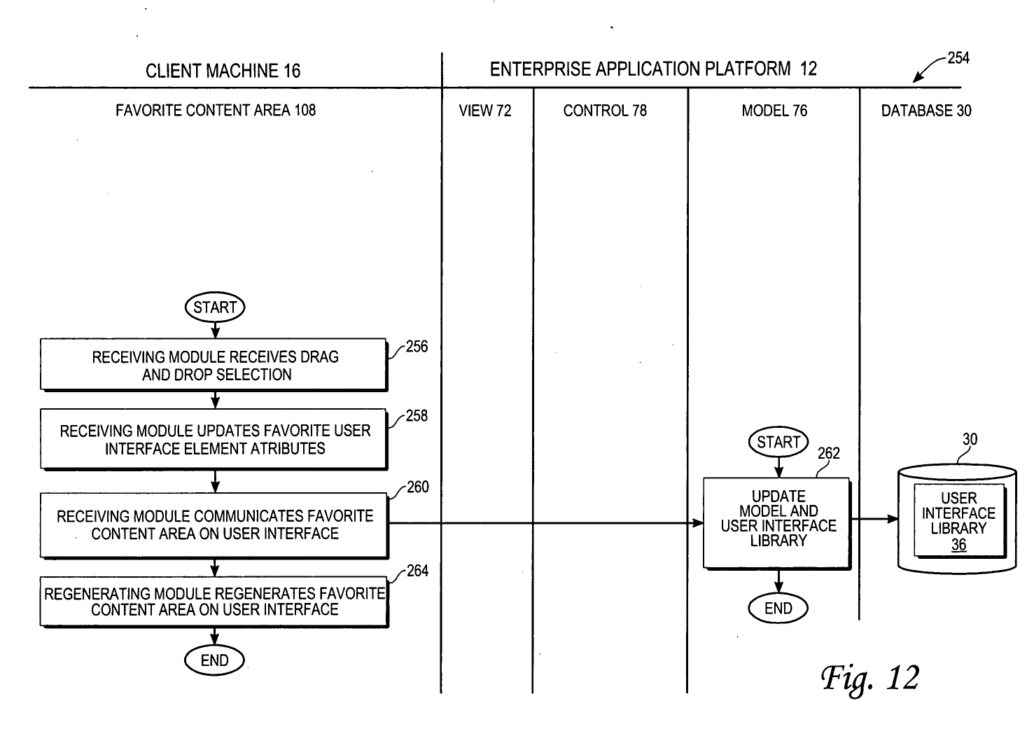

At box 252, the receiving module 78 in the user interface component 114 associated with the favorite content area 108 receives and processes an input event 77 for a drop and drag selection as illustrated on FIG. 12.

FIG. 12 illustrates a method 254, according to an exemplary embodiment, to facilitate access to a user interface element on a user interface. The client machine 16 is illustrated on the left and the enterprise application platform 12 is illustrated on the right.

At box 256, the receiving module 78, for the favorite content area 108, receives the drop and drag selection and, at box 258, updates the appropriate user interface element attribute 130 associated with the drop and drag selection. For example, the favorite attribute 136 and the favorite position attribute 138 for the present drop and drag selection would be updated.

At box 260, the receiving module 78, for the favorite content area 108, communicates the favorite attribute 136 and the favorite position attribute 138 for the dropped user interface element 92 (e.g., the employee resume leaf-category 202 on the tree 106) to the user interface model 83.

At box 262, the user interface model 83 updates the data elements corresponding to the favorite attribute 136 and the favorite position attribute 138 and saves a persistent copy of the attributes in the user interface library 36 in the database 30.

At box 264, the regenerating module 80 in the favorite content area 108 regenerates the favorite content area 108 to include the most recent drop and drag selection as illustrated in a user interface 267.

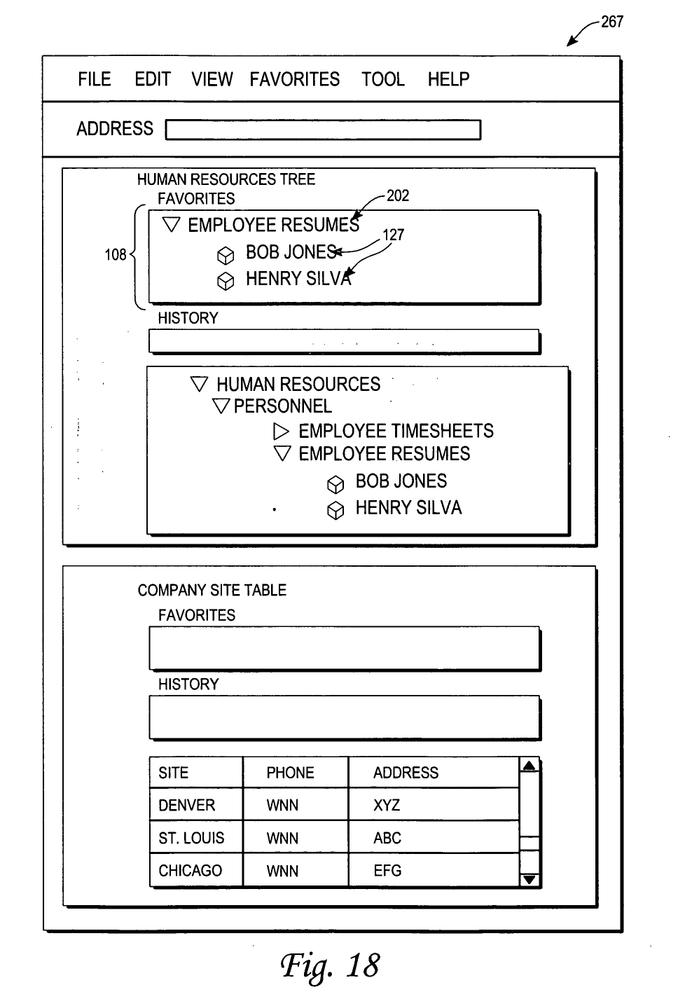

FIG. 18 illustrates the user interface 267, according to an embodiment, that includes the updated favorite content area 108. For example, the favorite content area 108 includes the drop and drag selection of the employee resume leaf-category 202 that includes objects 127 (e.g., resumes). It will be appreciated that a user may open, close or reposition the employee resume leaf-category 202 in the favorite content area 108. It will be further appreciated that closing the resume leaf-category 202 will hide the objects 127 contained within the resume leaf-category 202 and opening the resume leaf-category 202 will reveal the objects 127 contained within the resume leaf-category 202.

Returning to FIG. 11, at box 268, the user selects and closes the employee resume leaf category 202 in the tree 196 thereby generating an input event 77.

At box 270, the receiving module 78 in the user interface component 118 associated with the control content area 106 receives and processes the input event 77 as previously described in the method 206 that is illustrated on FIG. 10.

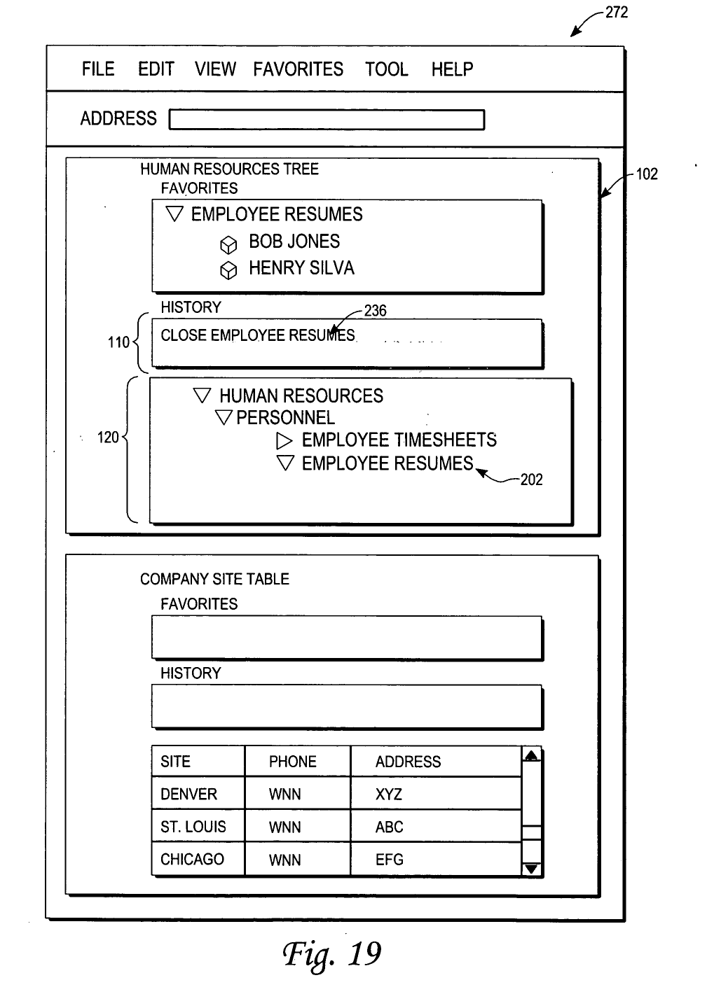

FIG. 19 illustrates a user interface 272, according to an embodiment, that includes an updated control content area 106 and an updated history content area 110. The history content area 110 is updated to include the most recent user selection (e.g., a string 236, “CLOSE EMPLOYEE RESUMES”) and the control content area 106 is updated responsive to the user selection (e.g., the employee resume leaf-category 202 is closed).

Returning to FIG. 11, at box 272, the user selects the resume of Bob Jones from the favorite content area 108 thereby generating of an input event 77.

At box 274, the receiving module 78, in the user interface component 114 associated with the favorite content area 108, receives the input event 77 and forwards the input event 77 to the receiving module 78 in the user interface component 118 associated with the control content area 106. The receiving module 78 in the user interface component 118 associated with the control content area 106 receives and processes the input event 77 as previously described in the method 206, as illustrated on FIG. 10.

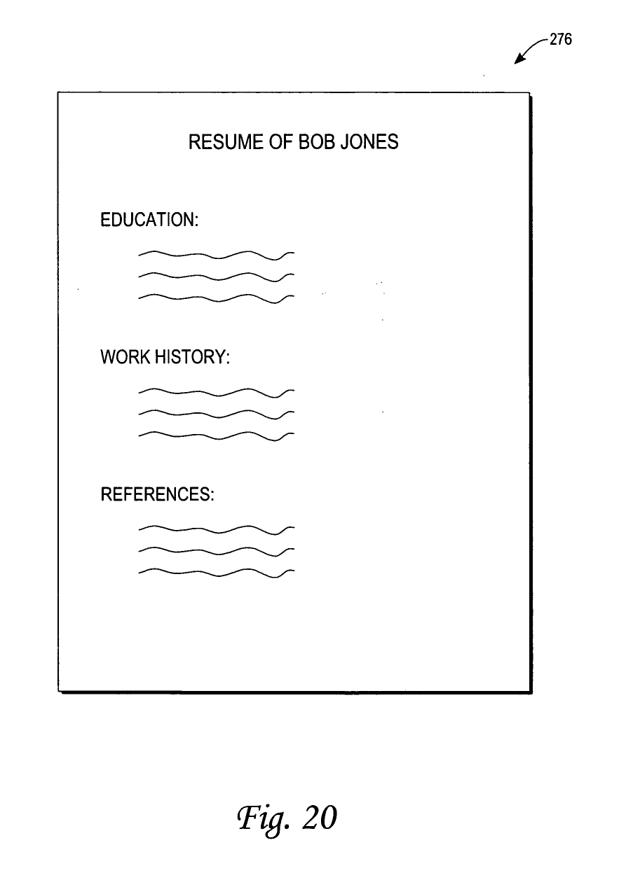

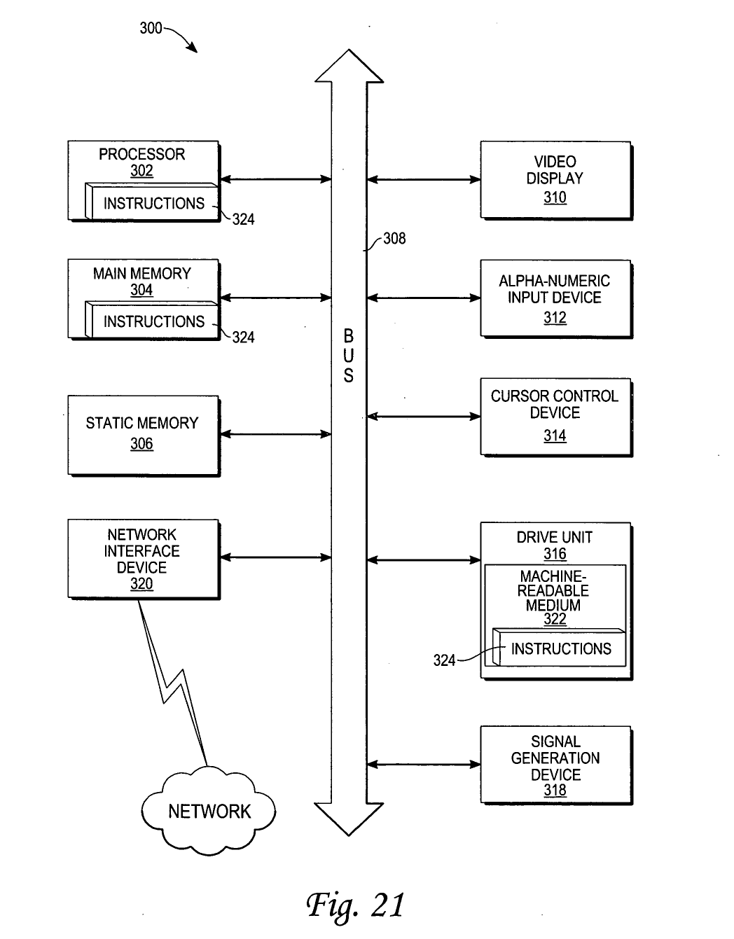

FIG. 20 illustrates a user interface 276, according to an embodiment, that displays the resume of Bob Jones.

Methods and systems to facilitate access to a user interface element on a user interface have been described with respect to exemplary embodiments that include a tree control 120; however, it will be appreciated that the described methods and systems may also include embodiments that include a table control 140. For example, a user may select user interface elements 92 from the table control 140. The selected user interface elements 92 may be stored in a retrieval content area 104 and retrieved from a retrieval content area 104, as previously described with respect to the tree control 120. The user interface elements 92 for a table control may include a scroll button 142, a row 144, a cell 146, a scroll bar 150 and a column 148. In addition, a table may also be searched with parameters 164 that are input by a user including keywords and filters. In this instance, the search parameters 164 may be stored in the respective user interface storage 88 for the user interface components 114, 116 and 118, and displayed and selected from the favorite content area 108 and/or the history content area 110 for subsequent execution.

The above-described embodiments illustrated a user operating a client machine 16 that included a web client 18 (e.g., smart browser) with scripting (e.g., JavaScript) enabled. It will be appreciated that processing is quite similar in an embodiment that includes a user operating a small device client machine 22 (e.g., a hand held device, PDA) or client machine 16 with a web client 18 (e.g., smart browser) with scripting (e.g., JavaScript) disabled or a web client 18 that does not support scripting (e.g., dumb browser). In the latter embodiments the user interface controllers 87 execute on the enterprise application platform 12 to receive and process input events 77 and to generate or regenerate web pages that are communicated to the client side.

FIG. 10 shows a diagrammatic representation of a machine or platform in the exemplary form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personnel computer (PC), a tablet PC, a set-top box (STB), a Personnel Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU) a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a cursor control device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions (e.g., software 324) embodying any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320.

While the machine-readable medium 322 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to facilitate access to a user interface element on a user interface have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A system to facilitate access to a user interface element on a user interface, the system including:
a receiving module to receive a first selection of a user interface element from a user interface control on the user interface; and
a regeneration module to regenerate a retrieval content area on the user interface based on the first selection, the retrieval content area being integrated with and dedicated to the user interface control, and the regeneration of the retrieval content area to enable a user to select the user interface element from the retrieval content area.

2. The system of claim 1, wherein the receiving module is to receive an execution selection of the user interface element from the retrieval content area, the execution selection to trigger an activity associated with the user interface element.

3. The system of claim 1, wherein the retrieval content area includes at least one of a history content area and a favorite content area.

4. The system of claim 3, wherein the user interface element is a favorite user interface element that is included in the favorite content area.

5. The system of claim 3, wherein the history content area includes most recent selections of a user.

6. The system of claim 1, wherein the user interface control includes a tree control and the first selection is to select any one of a group including to select a category, a sub-category, a leaf-category, and an object.

7. The system of claim 6, wherein the object includes any one of a group of items including an employee timesheet and an employee resume.

8. The system of claim 1, wherein the user interface control includes a table control and the first selection includes is to select any one of a group including a cell, a row, a column, a scroll bar, and search parameters.

9. The system of claim 1, wherein the first selection includes at least one of an execution selection and a drop and drag selection.

10. A system to facilitate access to a user interface, the system including:
at a first machine, a generation module to generate a user interface data message that includes a user interface controller to receive a first selection of a user interface element from a user interface control on the user interface, the first selection to trigger a regeneration of a retrieval content area on the user interface, the retrieval content area being integrated with and dedicated to the user interface control, the regeneration of the retrieval content area to enable the user to select the user interface element from the retrieval content area; and
a communication module to communicate the user interface data message from the first machine to the second machine.

11. A method to facilitate access to a user interface element on a user interface, the method including:
receiving a first selection of a user interface element from a user interface control on the user interface; and
regenerating a retrieval content area on the user interface based on the first selection, the retrieval content area being integrated with and dedicated to the user interface control, and the regeneration of the retrieval content area to enable a user to select the user interface element from the retrieval content area.

12. The method of claim 11, further including receiving an execution selection of the user interface element from the retrieval content area, the execution selection triggering an activity associated with the user interface element.

13. The method of claim 11, wherein the retrieval content area includes at least one of a history content area and a favorite content area.

14. The method of claim 13, wherein the user interface element is a favorite user interface element that appears in the favorite content area.

15. The method of claim 13, wherein the history content area includes most recent selections of a user.

16. The method of claim 11, wherein the user interface control includes a tree control and the first selection corresponds to selecting any one of a group including selecting a category, selecting a sub-category, selecting a leaf-category, and selecting an object.

17. The method of claim 16, wherein the object includes any one of a group of items including an employee timesheet and an employee resume.

18. The method of claim 11, wherein the user interface control includes a table control and the first selection corresponds to selecting any one of a group including selecting a cell, selecting a row, selecting a column, and selecting a position of a scroll bar.

19. The method of claim 11, wherein the first selection includes at least one of an execution selection and a drop and drag selection.

20. A method to facilitate access to a user interface, the method including:
at a first machine, generating a user interface data message that includes a user interface controller to receive a first selection of a user interface element from a user interface control on the user interface, the first selection to trigger a regeneration of a retrieval content area on the user interface, the retrieval content area integrated with and dedicated to the user interface control, the regeneration of the retrieval content area to enable the user to select the user interface element from the retrieval content area; and
communicating the user interface data message from the first machine to the second machine.

21. A machine readable medium storing a set of instructions that, when executed by a machine, cause the machine to:
receive a first selection of a user interface element from a user interface control on the user interface; and
regenerate a retrieval content area on the user interface based on the first selection, the retrieval content area integrated with and dedicated to the user interface control and the regeneration of the retrieval content area to enable a user to select the user interface element from the retrieval content area.

22. A machine readable medium storing a set of instructions that, when executed by a machine, cause the machine to:
at a first machine, generate a user interface data message that includes a user interface controller to receive a first selection of a user interface element from a user interface control on the user interface, the first selection to trigger a regeneration of a retrieval content area on the user interface, the retrieval content area being integrated with and dedicated to the user interface control, the regeneration of the retrieval content area to enable the user to select the user interface element from the retrieval content area; and
communicate the user interface data message from the first machine to the second machine.

23. A system to facilitate access to a user interface, the system including: at a first machine, a first means to generate a user interface data message
that includes a user interface controller to receive a first selection of a user interface element from a user interface control on the user interface, the first selection to trigger a regeneration of a retrieval content area on the user interface, the retrieval content area integrated with and dedicated to the user interface control, the regeneration of the retrieval content area to enable the user to select the user interface element from the retrieval content area; and
a communication module to communicate the user interface data message from the first machine to the second machine.
